(19) United States
(12) Patent Application Publication
(10) Pub. No.: US 2010/0253868 A1
(43) Pub. Date: Oct. 7, 2010

(54) METAL PATTERN STRUCTURE OF RESTRAINING STATIC DAMAGE OF THIN FILM TRANSISTOR LIQUID CRYSTAL DISPLAY

(76) Inventors: Tsu-Te Zen, Kaohsiung County (TW); Han-Tung Hsu, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 12/538,171

(22) Filed: Aug. 10, 2009

(30) Foreign Application Priority Data
Apr. 7, 2009 (TW) 098205540

(51) Int. Cl. G02F 1/1333

(52) U.S. Cl. 349/40

(57) ABSTRACT

The present invention relates to a metal pattern structure of restraining static damage of thin film transistor liquid crystal display. It includes a pattern discharge metal body; a pattern metal slice deposed opposite the pattern discharge metal body; and at least one pattern metal lump deposed between the pattern discharge metal body and the pattern metal slice and connected to the pattern metal slice. The present invention restrains the static damage of the pattern discharge metal body and the pattern metal slice, so as to avoid abnormal display picture like the phenomenon of the bright line.

### BACKGROUND OF THE INVENTION

1. Field of the Invention

The present invention relates to a metal pattern structure of thin film transistor liquid crystal display, more particular to a metal pattern structure of restraining static damage of thin film transistor liquid crystal display, which is used for the area of restraining static damage in the thin film transistor liquid crystal display. For example, it is used for the area of restraining the static damage of the gate's and the shorting bar's pattern metal or restraining the static damage of the source's and the shorting bar's pattern metal in the thin film transistor liquid crystal display.

2. Description of Related Art

The thin film transistor liquid crystal display has many pattern discharge metal bodies and many pattern metal slices deposed opposite the pattern discharge metal bodies respectively. The static damage's phenomenon is always happened between the pattern discharge metal body and the pattern metal slice, so as to cause the abnormal display picture of the thin film transistor liquid crystal display.

Please refer to the FIG. 1, which discloses a metal pattern structure of thin film transistor liquid crystal display 1. It includes a gate's pattern discharge metal body 11; and a shorting bar's pattern metal slice 12. When the current pass the gate's pattern discharge metal body 11, the gate's pattern discharge metal body 11 discharges electricity toward the shorting bar's pattern metal slice 12. Hence, the gate's pattern discharge metal body 11 and the shorting bar's pattern metal slice 12 are damaged by the static electricity, so as to form a first defect 111 on a side of the gate's pattern discharge metal body 11 and a second defect 121 on a side of the shorting bar's pattern metal slice 12. Hence, it will cause the abnormal display picture like the phenomenon of the bright line.

According to above prior art can be improved, the present invention provides a metal pattern structure of restraining static damage of thin film transistor liquid crystal display. It restrains the static damage of the pattern discharge metal body and the pattern metal slice to avoid the abnormal display picture like the phenomenon of the bright line.

### SUMMARY OF THE INVENTION

The main objection of the present invention is to provide a metal pattern structure of restraining static damage of thin film transistor liquid crystal display. It restrains the static damage of the pattern discharge metal body and the pattern metal slice to avoid the abnormal display picture.

The present invention provides a metal pattern structure of restraining static damage of thin film transistor liquid crystal display includes a pattern discharge metal body; a pattern metal slice deposed opposite the pattern discharge metal body; and at least one pattern metal lump deposed between the pattern discharge metal body and the pattern metal slice and connected to the pattern metal slice.

In order to make the aforementioned objects, features and advantages of the present invention comprehensible, preferred embodiments accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and together with the description, serve to explain the principles of the invention.

FIG. 1 is a schematic diagram of discharging electricity of a metal pattern structure of thin film transistor liquid crystal display in the prior art.

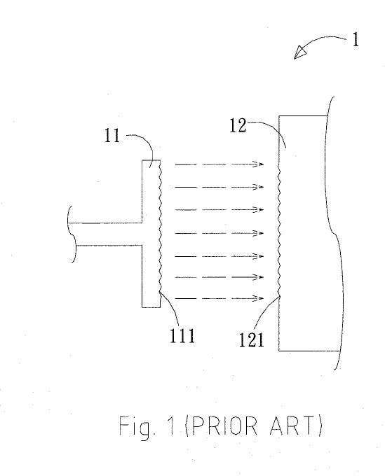

FIG. 2 is a schematic diagram of discharging electricity of a metal pattern structure of restraining static damage of thin film transistor liquid crystal display of a first embodiment in the present invention.

FIG. 3 is a schematic diagram of discharging electricity of a metal pattern structure of restraining static damage of thin film transistor liquid crystal display of a second embodiment in the present invention.

FIG. 4 is a schematic diagram of discharging electricity of a metal pattern structure of restraining static damage of thin film transistor liquid crystal display of a third embodiment in the present invention.

### DESCRIPTION OF PREFERRED EMBODIMENT

### First Embodiment

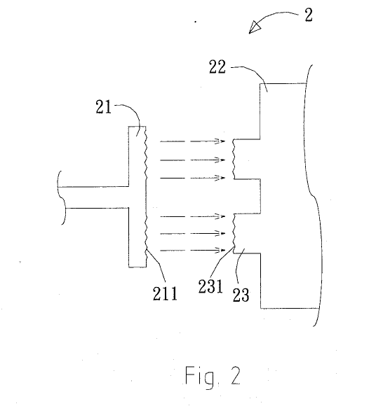

A metal pattern structure of restraining static damage of thin film transistor liquid crystal display 2 of the present invention is shown in FIG. 2. It includes a pattern discharge metal body 21; a pattern metal slice 22 deposed opposite the pattern discharge metal body 21; and at least one pattern metal lump 23 deposed between the pattern discharge metal body 21 and the pattern metal slice 22 and connected to the pattern metal slice 22. The static electricity of the pattern discharge metal body 21 is prior to damage a lateral of the pattern metal lump 23 to form a second defect 231 thereon and it is prior to damage a part of a lateral of the pattern discharge metal body 21 to form a first defect 211 thereon. Hence, the remainder part of the lateral of the pattern discharge metal body 21 and a lateral of the pattern metal slice 22 are not damaged by the static electricity.

In this embodiment, the pattern discharge metal body 21 is a T shape's pattern discharge metal body and the pattern discharge metal body 21 is a gate's pattern discharge metal body or a source's pattern discharge metal body. The pattern metal slice 22 is a shorting bar's pattern metal slice.

### Second Embodiment

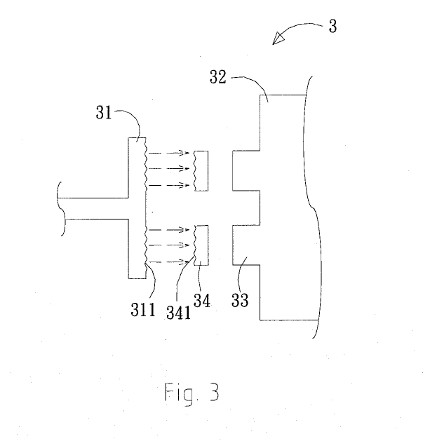

A metal pattern structure of restraining static damage of thin film transistor liquid crystal display 3 of the present invention is shown in FIG. 3. It includes a pattern discharge metal body 31; a pattern metal slice 32 deposed opposite the pattern discharge metal body 31; and at least one pattern metal lump 33 deposed between the pattern discharge metal body 31 and the pattern metal slice 32 and connected to the pattern metal slice 32; and a pattern metal body 34 deposed between the pattern discharge metal body 31 and the pattern metal lump 33. The static electricity of the pattern discharge metal body 31 is prior to damage a lateral of the pattern metal body 34 to form a third defect 341 thereon and it is prior to damage a part of a lateral of the pattern discharge metal body 31 to form a first defect 311 thereon. Hence, the remainder part of the lateral of the pattern discharge metal body 31, a lateral of the pattern metal slice 32 and a lateral of the pattern metal lump 33 are not damaged by the static electricity.

In this embodiment, the pattern discharge metal body 31 is also a T shape's pattern discharge metal body and the pattern discharge metal body 31 is a gate's pattern discharge metal body or a source's pattern discharge metal body. The pattern metal slice 32 is a shorting bar's pattern metal slice.

### Third Embodiment

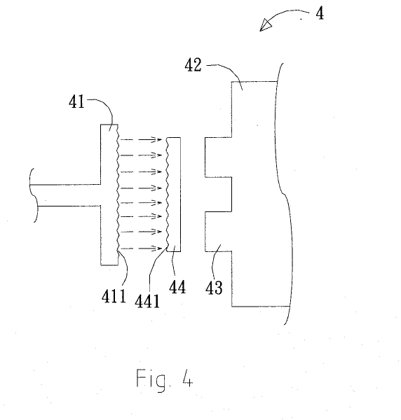

The metal pattern structure of restraining static damage of thin film transistor liquid crystal display 4 of the present invention is shown in FIG. 4. It includes a pattern discharge metal body 41; a pattern metal slice 42 deposed opposite the pattern discharge metal body 41; and at least one pattern metal lump 43 deposed between the pattern discharge metal body 41 and the pattern metal slice 42 and connected to the pattern metal slice 42; and a pattern metal strip 44 deposed between the pattern discharge metal body 41 and the two pattern metal lumps 43. The static electricity of the pattern discharge metal body 41 is prior to damage a lateral of the pattern metal strip 44 to form a forth defect 441 thereon and it is prior to damage a part of a lateral of the pattern discharge metal body 41 to form a first defect 411 thereon. Hence, a lateral of the pattern metal slice 42 and a lateral of the pattern metal lump 43 are not damaged by the static electricity.

In this embodiment, the pattern discharge metal body 41 is also a T shape's pattern discharge metal body and the pattern discharge metal body 41 is a gate's pattern discharge metal body or a source's pattern discharge metal body. The pattern metal slice 42 is a shorting bar's pattern metal slice.

According to above mention, the present invention restrains the static damage of the pattern discharge metal body and the pattern metal slice, so as to avoid abnormal display picture like the phenomenon of the bright line.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A metal pattern structure of restraining static damage of thin film transistor liquid crystal display, comprising:
a pattern discharge metal body;
a pattern metal slice deposed opposite the pattern discharge metal body; and
at least one pattern metal lump deposed between the pattern discharge metal body and the pattern metal slice and connected to the pattern metal slice.

2. The metal pattern structure of restraining static damage of thin film transistor liquid crystal display according to the claim 1, wherein the pattern discharge metal body is a T shape's pattern discharge metal body.

3. The metal pattern structure of restraining static damage of thin film transistor liquid crystal display according to the claim 1, further comprising a pattern metal body deposed between the pattern discharge metal body and the pattern metal lump.

4. The metal pattern structure of restraining static damage of thin film transistor liquid crystal display according to the claim 1, further comprising a pattern metal strip deposed between the pattern discharge metal body and the two pattern metal lumps.

5. The metal pattern structure of restraining static damage of thin film transistor liquid crystal display according to the claim 1, wherein the pattern discharge metal body is a gate's pattern discharge metal body.

6. The metal pattern structure of restraining static damage of thin film transistor liquid crystal display according to the claim 1, wherein the pattern discharge metal body is a source's pattern discharge metal body.

7. The metal pattern structure of restraining static damage of thin film transistor liquid crystal display according to the claim 1, wherein the pattern metal slice is a shorting bar's pattern metal slice.
